(19) United States
(12) Patent Application Publication
(10) Pub. No.: US 2007/0268123 A1
(43) Pub. Date: Nov. 22, 2007

(54) Converting raw data to representative information for indicators or actuators

(75) Inventors: Edward K.Y. Jung, Bellevue, WA (US); Eric C. Leuthardt, St. Louis, MO (US); Royce A. Levien, Lexington, MA (US); Robert W. Lord, Seattle, WA (US); Mark A. Malamud, Seattle, WA (US); John D. Rinaldo, Bellevue, WA (US); Lowell L. Wood, Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC. a limited liability corporation of the State of Delaware

(21) Appl. No.: 11/438,917

(22) Filed: May 22, 2006

(51) Int. Cl. G08B 1/00; G08B 3/00

(52) U.S. Cl. 340/531; 340/691.6

(57) ABSTRACT

One aspect relates to detecting raw indicator data at least partially from an indicator; and converting the raw indicator data to indicator-representative information at least partially based on an indication by the indicator at least partially in response to the detecting the raw indicator data. Another aspect relates to detecting raw actuator data at least partially from an actuator, and converting the raw actuator data to actuator-representative information at least partially in response to the detecting the raw actuator data.

### TECHNICAL FIELD

Certain aspects of this disclosure can relate to, but are not limited to, a mechanism or technique that can convert raw data to representative information, which can be used to represent an indicator or actuator.

### BRIEF DESCRIPTION OF THE FIGURES

FIG. 1 is a block diagram of one embodiment of an indicator positional converter mechanism;

FIG. 2 is a diagram of an embodiment of the indicator positional converter mechanism;

FIG. 3 is a diagram of another embodiment of the indicator positional converter mechanism;

FIG. 4 is a diagram of yet another embodiment of the indicator positional converter mechanism;

FIG. 5 is a diagram of still another embodiment of the indicator positional converter mechanism;

FIG. 6 is a diagram of another embodiment of the indicator positional converter mechanism;

FIG. 7 is a diagram of yet another embodiment of the indicator positional converter mechanism;

FIG. 8 is a diagram of still another embodiment of the indicator positional converter mechanism configured as a moving map;

FIG. 9 is a diagram of one embodiment of the indicator detector 104 as described with respect to FIG. 1;

FIG. 10 is a diagram of another embodiment of the indicator detector 104 as described with respect to FIG. 1;

FIG. 11 is a diagram of one embodiment of a vehicle operation feedback mechanism;

FIG. 12 is a diagram of one embodiment of an actuator positional converter mechanism;

FIG. 13 is a block diagram of an embodiment of the actuator positional converter mechanism;

FIG. 14 (which includes FIGS. 14a, 14b, 14c, and 14d) is a flowchart of one embodiment of an indicator converter technique; and

FIG. 15 is a flowchart of one embodiment of an actuator converter technique.

### DETAILED DESCRIPTION

At least certain portions of the text of this disclosure (e.g., claims and/or detailed description and/or drawings as set forth herein) can support various different applications. Although, for sake of convenience and understanding, the detailed description includes section headings that generally track various concepts, and is not intended to limit the scope of the invention as set forth by each particular claim. It is to be understood that support for the various applications thereby can appear throughout the text and/or drawings, irrespective of the section headings.

### 1. Certain Embodiments of a Positional Converter Mechanism

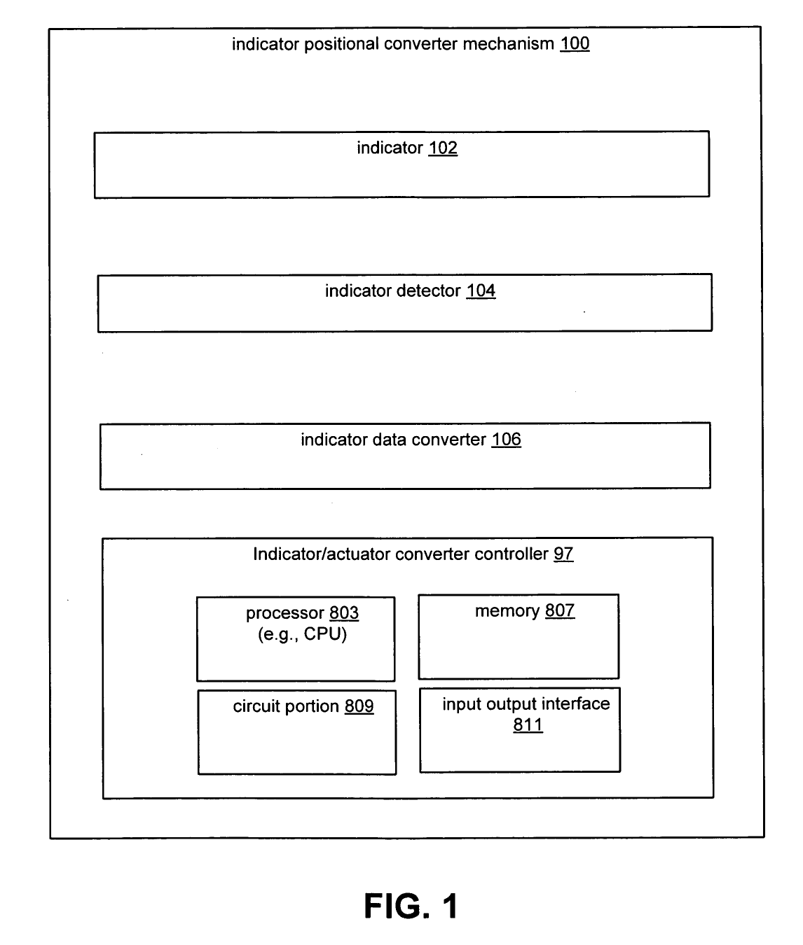

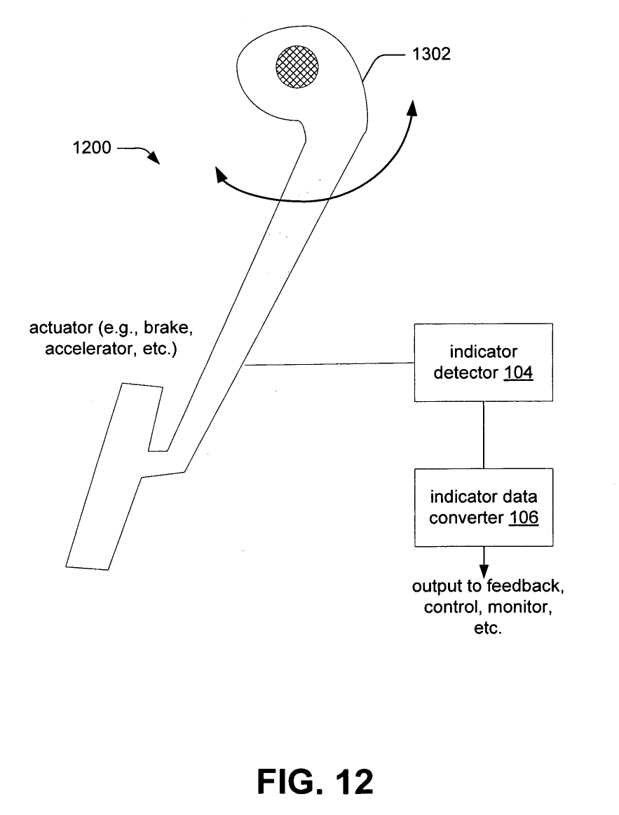

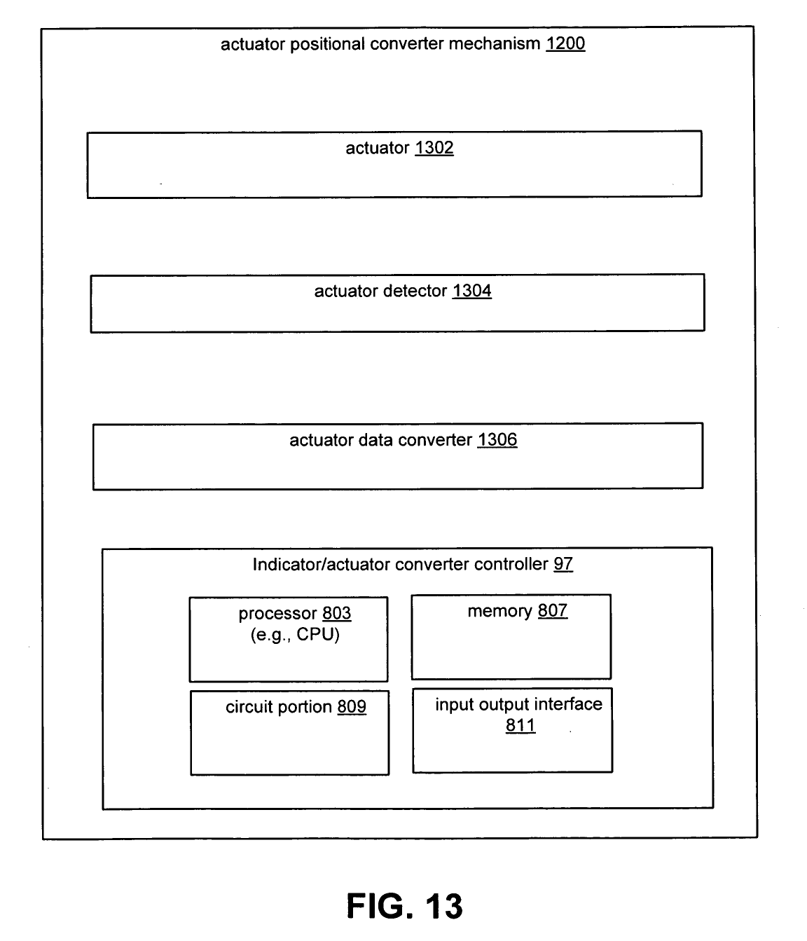

There are a number of embodiments of a positional converter mechanism, which each can output information or data such as data corresponding to a position or value of an operator-related device such as an indicator or an actuator. FIG. 1, for example, describes a number of embodiments of an indicator positional converter mechanism that can convert a raw indicator data (which may be in the form of a value or position) of an indicator such as a speedometer or clock into indicator-representative information or data, that can be stored, analyzed, retrieved, processed, etc. By comparison, as described later in this disclosure, FIGS. 12 and 13 describe an embodiment of an actuator positional indicator that can convert a raw indicator data value or position of an actuator such as a brake-pedal or accelerator into actuator-representative information or data that can be stored, analyzed, retrieved, processed, etc.

Certain aspects of this disclosure can relate to a variety of the indicator positional converter mechanism 100, as well as a variety of techniques associated therewith. Certain embodiments of the indicator positional converter mechanism 100 as described with respect to FIG. 1 can include, but are not limited to, an indicator 102, an indicator detector 104, and/or an indicator data converter 106. Certain embodiments of the indicator 102 can be configured as an analog indicator, a digital indicator, a biological indicator, or other types or hybrid combinations of indicators. Certain embodiments of the indicator 102 can be configurable to be readable by a human such as a vehicle's operator, a driver, a pilot, a power station's operator, a machine's operator or user, a biological system's operator or user, a system's operator or user, etc. Certain embodiments of the indicator detector 104 can be configured to include a camera, a digital imager, a scanner, an encoder, etc. in order to read a value of the indicator 102. This disclosure describes a variety of the indicator 102 that can be utilized which provide an indication of the variety of applications of the indicator positional converter mechanism 100.

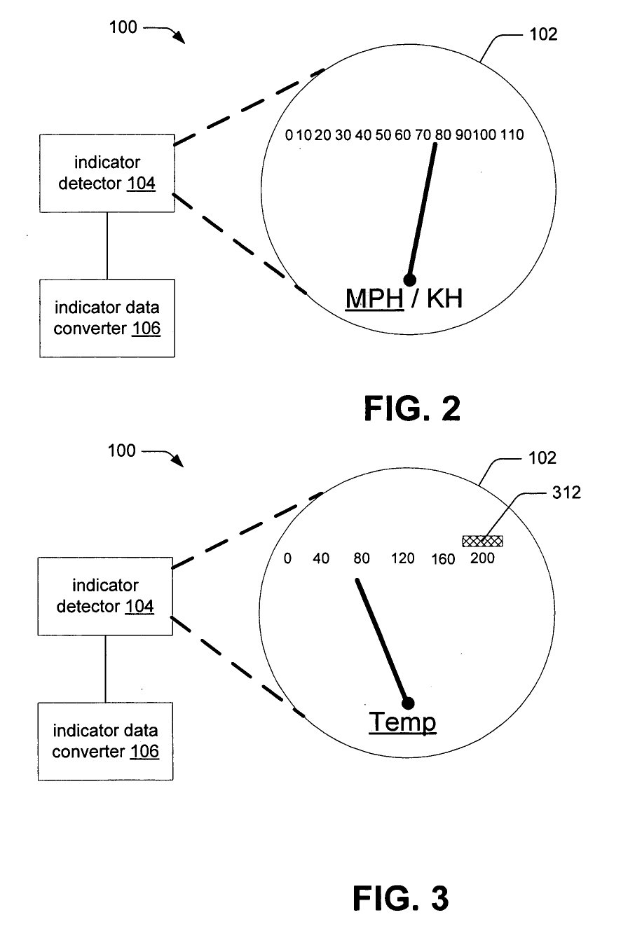

Certain embodiments of the indicator 102 can be configured as an analog device, as described with respect to FIGS. 2 to 6. These illustrative embodiments of the indicator can be integrated into the indicator positional converter mechanism 100. FIG. 2, for example, illustrates an analog speedometer that can be utilized to measure the velocity of a land vehicle such as an automobile, a truck, a bus, a military vehicle, a railroad locomotive, etc.; an air vehicle such as an aircraft, a helicopter, a rocket, or a spacecraft; or alternately a sea vehicle such as a boat or a ship. Even with the commercial acceptance of many digital indicators, certain embodiments of the analog indicators (such as speedometers, airspeed indicators, altimeters, course deviation indicators (CDIs), etc.) as described in this disclosure remain within common usage, and in certain instances may even be preferred.

Certain embodiments of the indicator detector 104 can be configured to image, encode, detect, record, or otherwise ascertain one or more values of raw indicator information that may be presented by the indicator 102. A number of embodiments of the indicator detector 104 are described in this disclosure, but certain embodiments may include, but are not limited to: cameras, imagers, scanners, detectors, encoders, etc. As such, certain embodiments of the indicator detector 104 can be configured to detect at least one output of the indicator 102 as it may appear to a user or operator of the indicator.

With certain embodiments of the indicator positional converter mechanism 100, certain operators may prefer using analog indicators for reasons such as, but not limited to, because especially when viewing a large amount of information, it may be easier for the user to interpret a position of an analog indicator as compared to certain numeric outputs of a digital indicator. The use of such analog embodiments of indicators as analog speedometers, analog tachometers, analog altimeters, etc. are still in common usage largely because of their ease of readability by users and/or operators, attractiveness, ruggedness, expected lifetime, ease to discern difference from a desired range of values or value by users and/or operators, and/or ease to detect changes in values of the indicator by users and/or operators. In addition, certain users or operators still prefer the traditional, legacy, or analog appearance of many indicators. Additionally, it may be easier to visualize by color-coding certain regions 312 of an analog indicator that is color-coded for certain regions. For example, a temperature indicator or thermometer such as illustrated in FIG. 3 can be color-coded, such as by including a colored line or colored band 312 (red, orange, yellow, or other color, or combination of colors) which may be positioned at some appropriate location to indicate a prescribed condition for a vehicle, home, thermometer, machine, medical device, etc. It may be preferred to use certain digital embodiments of the indicator positional converter mechanisms for certain reasons perhaps including but not limited to response time, device lifetime, appearance, ease of use, etc. Certain embodiments of the temperature indicator as described with respect to FIG. 3 can indicate the temperature of a vehicle, temperature of a machine, temperature of a medical device, temperature of a dwelling, temperature of an office or business, and/or an outside temperature, etc.

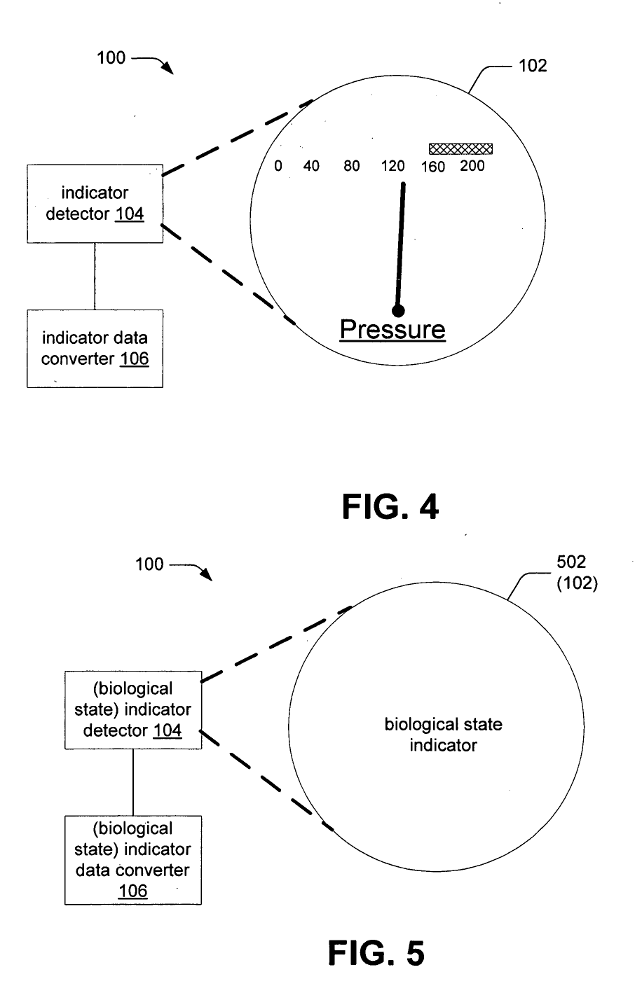

FIG. 4 illustrates an embodiment of an analog pressure indicator that can be utilized on a vehicle such as a ship, aircraft, a machine, a medical device, a system, a process, etc. For example, the pressure indicator may indicate, in an analog fashion, such humanly-interpretable indications as the pressure of the machine, medical device, process, or vehicle, the environmental pressure outside or in a building, etc. In certain instances, analog pressure indicators may be preferable as compared with certain digital indicators since certain analog indicators can display ranges of values, such as normal operating range values, caution range values, do not exceed values, etc. Certain embodiments of such analog pressure indicators as described with respect to FIGS. 2, 3, and 4 may be in common usage largely because they are relatively easy for an operator to scan through a number of indicator parameters and/or indicators during operation of a vehicle, machine, medical device, process, or system; especially for those vehicles, machines, medical devices, processes, or systems having a considerable number of instruments.

Certain embodiments of the analog indicator 102 can be used during operation of a machine, a plant, a medical device, a mechanism, a process, etc. As such, it can be intended that a number of embodiments of the indicator positional converter mechanism 100 can be applied to a large number of machine, medical device, industrial, home, office, or other indicators. Certain embodiments of information or data corresponding to the raw data or information as provided by the indicators 102 that can be monitored and/or translated into a form that can be interpreted remotely from the indicator positional converter mechanism 100. For example, the output information or output data corresponding to the raw data or information can affect a process, or alternately be transferred to another viewer, another portion of the indicator positional converter mechanism 100, or another device such that it can communicate using network, computer, or communications technology. A remote user situated at the remote device, for example, can analyze the information such as to assist the operator in operation or process, provide an alarm to the user or operator if the system or device is outside of a prescribed operating range, critique the operator in operating, and/or instruct the operator in operating the vehicle, medical device, machine, plant, etc.

One illustrative example of such an analog indicator 102 can be used for monitoring and/or controlling an operation of a nuclear or other power generation plant (consider the power grid for an area such as the Northeast United States). While it may be desirable to utilize a variety of indicators 102 as described herein, it may also be desired to provide some feedback or control within the indicator positional converter mechanism 100 based at least partially in response to a state, condition, or position of the indicator 102. A considerable number of the indicators, for example, can be utilized in the control room of a nuclear plant or an electric grid. Certain embodiments of the indicator(s) 102 can be configured with certain embodiments of the indicator positional converter mechanism 100 to allow operators to monitor a number of real-time operations or processes occurring within the machine, medical device, plant, mechanism, process, etc. Certain embodiments of the indicator positional converter mechanism as described in the present disclosure can allow for a record to be made of the parameters or output readings of the one or more indicator(s) 102. By providing a record of one or more of the indicator(s) during plant, medical device, machine operation or output readings, for example, a reviewer could consider whether the operator violated a regulation during a particular operation of a plant, medical device, machine, or other device, etc. By providing a record at one or more of the indicator(s) associated with vehicles, for example, a reviewer could consider whether the operator has been effectively or ineffectively operating the vehicle. In addition, providing a record of the indicator 102 can indicate whether an embodiment of the indicator itself is/has been providing a correct or erroneous indication to the operator.

FIG. 5 shows one embodiment of the indicator positional converter mechanism 100 that can be configured to indicate, with data in a converted form, a state of a biological state indicator 502 (which is one embodiment of the indicator). Within this disclosure, certain embodiments of the biological state indicator include an indicator that can indicate, using at least one living organism, a state or condition being indicated. Certain embodiments of the biological state indicator can utilize insects, viruses, bacteria, or other suitable living organisms that can indicate a condition or state using the indicator 502. For instance, certain bacteria might change color in the presence of certain materials, chemicals, fluids, elements, etc. As such, certain embodiments of the biological state indicator 502 can be configured to indicate the presence or absence of such materials, chemicals, fluids, elements, etc. based at least in part on their color. Based upon the color of the biological state indicator, certain embodiments of the indicator detector 104 can encode or capture the condition of the biological state indicator 502. The captured or encoded condition can be converted, such as to digital form, which in certain embodiments can be processed, monitored, analyzed, transmitted, received, and/or associated with some type of feedback mechanism as described in this disclosure. Embodiments of the biological state indicator can be as varied in size to provide some indication from a very small or microscopic area (e.g., does a particular microscopic slide indicate a presence or absence of some chemical, state, constituent, fluid, element, etc.), to a large area (e.g., does the overall color of living organism or a large field indicate some chemical, state, constituent, fluid, element, etc.). Certain embodiments of the biological state indicator can be effected by considering a natural state with little or no input by man. For example, colors of a particular type of plant or biological organism in a field, stream, etc. may indicate the concentration of chemicals, fertilizers, minerals, constituents, fluids, elements, etc. in the soil, or alternately at a state of one or more of the plants or living organisms.

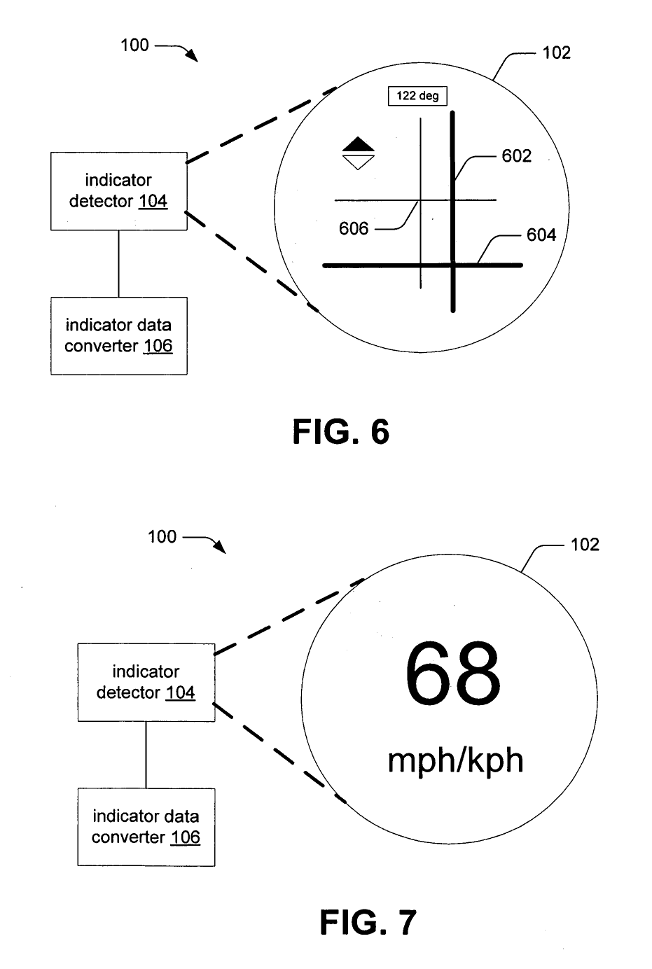

FIG. 6 shows another embodiment of the indicator 102 that can be configured to include multiple distinctly-operating indicators. The indicator 102, similar to as shown in FIG. 6, can be used in aircraft navigation, for example. The first indicator can include a course deviation indicator (CDI) 602 to indicate whether the aircraft is right, left, or centered on a desired course relative to a navigational aid, and the second indicator 102 can include a glide slope indicator 604 that can indicate whether the aircraft is above, below, or centered on a desired altitude or glide slope. Both indicators 602 and 604 can be used to provide a distinctly quantifiable indication of positional information of an aircraft or spacecraft. The CDI 602 indicates, for example, the horizontal angular position of the aircraft or spacecraft with respect to a particular navigation aid and/or airport based at least in part on a selected course (e.g. 122 degrees in FIG. 6). Certain embodiments of the navigation aid may or may not be situated at an airport; and certain navigational aids that are associated with an airport may be associated with the particular runway at that airport. For instance, in FIG. 6, the indicator 602 indicates that the aircraft would be a number of degrees to the right of the selected course (as indicated by the CDI 602 being situated to the right of a cross-hair 606).

Certain embodiments of the glide slope indictor 604 can indicate, for example, the vertical angle of the aircraft with respect to a navigational aid that may be situated, for example, relative to a runway or landing zone at an airport. For instance, in FIG. 6, the aircraft could be a number of degrees above the desired path as indicated by the deflection of the glide slope indicator 604 relative to the cross-hair 606 (e.g., the glide slope indicator being situated below as illustrated in FIG. 6).

Certain embodiments of the indicator 102 such as described with respect to FIG. 1 or 6, for example, can be used in a regulated operation (e.g., regulated by the FAA a regulatory commission or a department of transportation), such as if either the CDI 602 and/or the glide slope indicator 604 are deflected beyond a prescribed range (such as a full-scale deflection as indicated by the instrument), then further flight operations such as an approach below that altitude may not be allowed, and the pilot must execute a missed-approach unless they can see and land at the runway. For example, if the CDI 602 and/or the glide slope indicator indicated a fully deflected state during an approach operation, the operator or pilot may be required to discontinue the approach to a particular runway under certain circumstances. There may be a number of other embodiments of the indicators that can indicate an operation of a vehicle or system that can be regulated by some law or regulation. For example, a speedometer for a car or truck can indicate whether the driver is speeding or traveling too slow along a roadway. Certain embodiments of a speedometer to be used in a locomotive can indicate whether the train is traveling too fast for a section of track. Violating such vehicle speed or operation rules or law may violate some law or statute.

Certain embodiments of the indicator positional converter mechanism 100 can provide a storable, processable, recallable record of the indicator that can be utilized in a regulated operation, such as the indicator 102 as described with respect to FIG. 6. By providing a record of such an indicator during an approach or navigation of an aircraft, for example, a reviewer could consider whether a pilot or operator violated a regulation during a particular aircraft operation such as an approach or an en route portion of a flight. In addition, providing a record of the indicator 102 such as instruments can indicate whether certain embodiments of the indicator are providing a correct or erroneous indication to the operator. Such information could be extremely valuable in ascertaining a cause of an accident, determining whether an operator was in error, determining whether the indicator 102 was in error, etc. As such, certain embodiments of the indicator positional converter mechanism 100 can indicate what an operator utilizing the indicator 102 could have or did observe.

Certain embodiments of the indicator positional converter mechanism 100 can be configured to determine whether the vehicle is being operated in an erratic manner, such as by a drunk driver or a driver who is falling asleep. Certain embodiments of the indicator positional converter mechanism 100 can include an alarm or control circuitry that can limit operation of the vehicle under such circumstances.

Certain embodiments of the analog indicator 102, as described with respect to FIGS. 2 to 6, can be included in the indicator positional converter mechanism 100 and in combination with a feedback mechanism, such as to provide a record, indicator, and/or a control of the object or vehicle. While cruise controls for automobiles, autopilots for aircraft or ships, feedback mechanisms for machines, medical devices, processes, or systems, and the like are in common usage, are generally understood in their respective arts, and are commercially available, certain ones of these systems can rely upon the operation of the system or vehicle. Such systems can thereby utilize digital information that may not be derived from, or necessarily displayed on, the indicator 102. For example, while a cruise control of an automobile, truck, aircraft, ship, etc. can at least partially utilize a digital output to maintain some output relating to the operation of the vehicle. Consider that in traditional cruise-control systems, for example, the output of the speedometer does not have to operate in sync with the operation of the cruise control, such as would be the case as might allow the cruise control to be operating even when the speedometer is faulty or broken.

Certain embodiments of the indicator positional converter mechanism 100 may be configured to convert raw data as output from other indicators than the analog indicators, as described with respect to FIGS. 2 to 6. For example, FIG. 7 discloses a digital embodiment of the indicator 102 (such as a speedometer) that can include a digital readout of one or more parameters pertaining to the vehicle. The output of the indicator data converter 106 as described with respect to FIG. 7 may provide a different value than the digital input to the indicator 102. For example, consider those instances when the indicator is broken or mis-adjusted. The output of the indicator data converter 106 can indicate the information or data that can be viewed by the user or operator. Certain digital embodiments of the indicator could include a digital speedometer, digital velocity indicator, digital altimeter, digital depth indicator, digital machine process indicator, digital medical device indicator, digital clock, digital temperature indicator, digital pressure indicator, or other digital output indicator. Such devices that can detect, monitor, or measure or detect a parameter to provide the information may include, but are not limited to, a variety of devices that may relate to a single parameter such as a thermometer, an oven temperature indicator, or a process temperature indicator, can all relate to indicating temperature.

With certain vehicles, machines, medical devices, processes, systems, etc. such as those that may be relatively complex or confusing for the human operator to oversee, certain embodiments of the indicator positional converter mechanism 100 can be applied to digital outputs can allow the user or operator to monitor for unusual or hazardous states which may otherwise go undetected. For instance, a nuclear power plant or electric power grid may have a number of pressures, temperatures, positions, etc. that may be difficult, expensive, or monotonous for a user or operator to observe reliably in a day-to-day manner. It may be extremely important, however, to ensure such indicators are continually monitored. As such, certain embodiments of the indicator positional converter mechanism 100 may be equipped with one or more alarms to alert the user or operator of certain situations. Such alerts or alarms may be useful, for example, for users or operators of complex vehicles such as aircraft, ships, submarines, spacecraft, etc. as well as operators of more operationally simple devices, systems, or processes.

Certain embodiments of the indicator positional converter mechanism 100 can be configured to convert raw indicator data that could be observed or seen by certain users or operators. Even if some raw indicator data could be seen or observed by certain operators and users, other users or operators may not be situated relative to the indicator, or have the ability to detect information corresponding to the raw indicator data of the indicator. For instance, certain users or operators may be situated at relative positions with respect to the indicator 102. Certain users or operators may have poor eyesight, or have the inability to see certain output. As such, output from the indicator 102 is configured to be observed by certain users or operators which may not be detectable by all users or operators.

Certain embodiments of the indicator positional converter mechanism 100 can be configured to output data or information that is generally not detectable by humans. For example, certain indicators may output digital information which can be transmitted in a digital manner or an encoded manner. In addition, certain “indicators” may produce as raw indicator data infrared radiation, ultraviolet radiation, or other electromagnetic radiation that is not viewable by certain humans. As such, though the indicator data converter 106 can be configured to convert certain embodiments of indicator information that can be observed, certain embodiments of the raw indicator information may be in a form that may not be generally observable or detectable by humans. Certain embodiments of the indicator data converter 106 can thereby be configured to convert raw indicator data that can be read by machines, computers, etc., is not viewable by certain humans, or alternately can be arranged in a random or pseudo-random form.

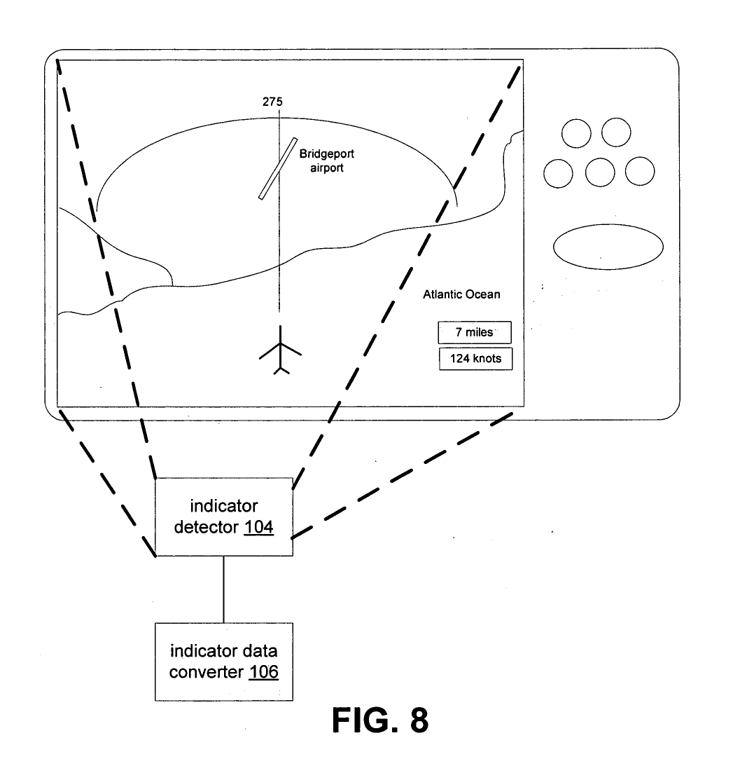

FIG. 8 shows a moving map embodiment of the indicator 102. Certain moving map embodiments of the indicator may be configured to provide positional information of an individual, a vehicle (including but not limited to land, sea, or air vehicles as described in this disclosure), or a device. Commercially available moving maps have become more commonplace recently to provide GPS (or other positional information) to users such as pilots, car drivers, hikers, ship captains, etc. Certain embodiments of the positional information can be provided in one or two dimensions, two dimensions with topography which may be considered as three dimensions, multiple instances of two dimensions (e.g., a plan view plus an elevational view), and/or three dimensions. Certain embodiments of the positional information may be utilized in certain embodiments of the moving map and can be provided using, for example but not limited to, a global positioning system (GPS), Radar, Loran, or other suitable positional technologies. Certain moving map embodiments of the indicator 102 can be configurable such as displaying information in color or in black-and-white; can include suitable readouts of digital, analog, or other suitable information; can include a suitable user interface to allow sizing, orientation, or display elements to be selected by the operator, etc. A variety of embodiments of the indicator 102, as described with respect to FIGS. 1 to 8, can therefore be included in certain embodiments of the indicator positional converter mechanism 100.

A number of embodiments of the indicator detector 104 can interface with the embodiments of the indicator 102 as described with respect to FIGS. 1 to 8. Certain embodiments of the indicator detector 104 can thereby be configured to detect the raw indicator data that can be at least partially generated from a number of embodiments of the indicator 102. Certain embodiments of the raw indicator data can include, but is not limited to, information or data that can indicate what the indicator 102 can indicate or display to a user, operator, or observer of the indicator detector 104. As such, the raw indicator data or information can be recorded, processed, analyzed, used within a feedback-loop, etc. to indicate what a user or operator of the indicator could have seen, detected, or observed when viewing the indicator. By recording the raw indicator data, a record (which can be made temporary or more permanent depending upon information or data type and storage type) can be made of what the observer or operator of the indicator 102 could have viewed.

Such records of the raw indicator data can be useful, for example, in vehicle accident or crash situations to determine a cause of the accident; as combined with feedback mechanism to provide automated control of the vehicle, machine, medical device, manufacturing plant, etc. such as for an autopilot or cruise control; or during an evaluation or instruction to an operator of the vehicle, machine, medical device, manufacturing plant, etc. In the case of an indicator 102 that could be used in such a vehicle as an automobile, truck, aircraft, ship, military vehicle, etc., the raw indicator data could thereby correspond to the information which the operator could use to operate the vehicle and/or the environment thereabout.

Certain embodiments of the indicator data converter 106 can be configured to convert the raw indicator data to indicator-representative information at least partially in response to detecting the raw indicator data. Certain embodiments of the indicator-representative information measure the operation of the vehicle, machine, medical device, plant, system, etc. and could be monitored by the user. Certain embodiments of the indicator-representative information can be in a form that can be utilized by a computer, a network, or a communication system such as may be commercially available, or generally understood by those skilled in the respective technologies. As such, certain embodiments of the indicator-representative information could be transmitted from location to location, and could be used to detect what an operator saw at a particular time, or range of times.

Certain embodiments of the indicator positional converter mechanism 100 can include the indicator detector 104 which can detect a state, condition, position, or other aspect of the indicator 102. Certain embodiments of the indicator detector 104 can be configured as a camera, an imaging device, an optical scanning device, an optical or acoustic sensing device, or an encoder, etc. that could capture, image, or otherwise record raw indictor information that can be output by the indicator 102.

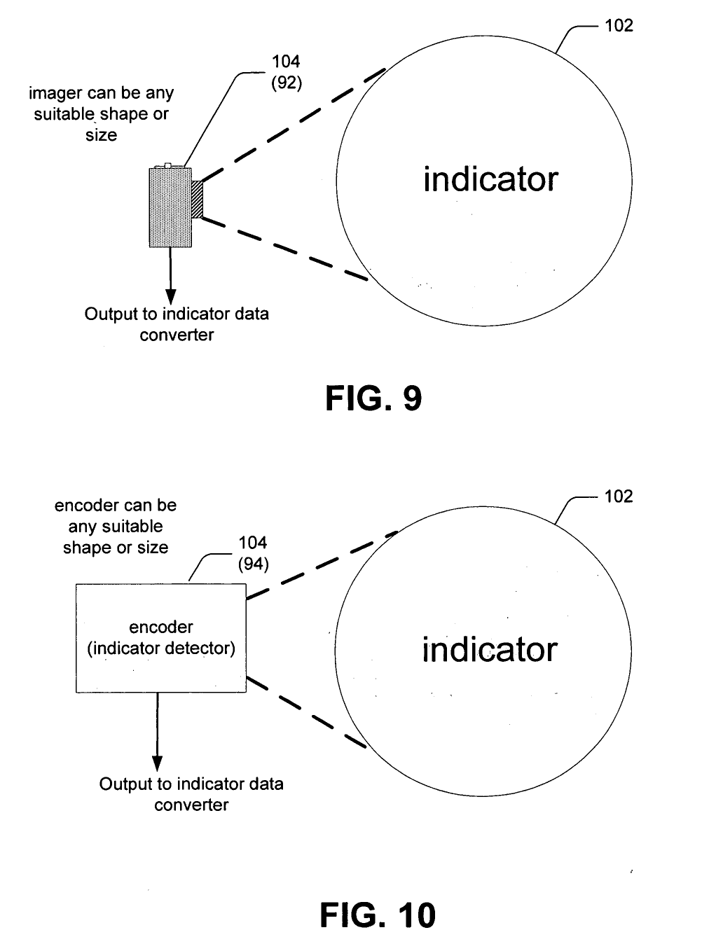

Certain embodiments of the indicator data converter 106 could convert the raw indicator data (such as detected by the indicator detector 104) to the indicator-representative information. Certain embodiments of the indicator-representative information can be input into or utilized by the controller or a computer to monitor or detect an operation, state, or condition of the indicator. The detected monitored operation, state, or condition of the indicator can, in turn, be fed into an actuator (not illustrated) which may be utilized to actuate an associated feedback mechanism-based device. Certain embodiments of the indicator data converter 106 can use computer, imaging, or controller technology which could include but is not limited to personal display assistants (PDAs), desktop computers, laptop computers, cellular phone, motes, or other computer or controller systems to capture, take, enlarge, reduce, filter, store and/or otherwise process images corresponding to the indicator-representative similar to what is described with respect to FIG. 9. As such, certain embodiments of the indicator-representative information can be based, at least in part, on imaged or captured raw indicator data.

Certain embodiments of the indicator data converter 106 can utilize encoding technology as described with respect to FIG. 10 to determine the state, condition, or position of the indicator. As such, certain embodiments or the indicator-representative information can be based, at least in part, on encoded raw indicator data. Certain embodiments of the selection of capturing the time, duration, frequency of multiple images, details of the images, or other characteristics of the indicator-representative information can be performed at least in part using a number of user interfaces or control mechanisms. Repetition or sampling within the imaging and/or encoding processes can be performed at a variety of rates and/or speeds, depending upon such factors as rate of change of the indicated raw indicator data, expense of sampling, importance of detection, etc.

Certain embodiments of the indicator positional converter mechanism 100 can thereby interface with indicators utilizing traditional human-centric technologies, such as cameras, imagers, scanners, etc. to provide feedback or control. Certain embodiments of the indicator data converter 106 can be configured to provide control and/or feedback for the indicator positional converter mechanism 100. For instance, certain embodiments of the indicator 102 can include a mercury bulb thermometer or other temperature indicator as described with respect to FIG. 3, or could include a pressure device having human-readable markings as described with respect to FIG. 4. Thereby, certain embodiments of the indicator positional converter mechanism 100 may be able to perform temperature, pressure, or other parameter sensing. Certain embodiments of the indicator detector 104 of the indicator positional converter mechanism 100 can thereby utilize cameras, imagers, encoders, and/or the like.

Certain embodiments of the indicator data converter 106 of the indicator positional converter mechanism 100 can be at least partially utilized to provide feedback utilizing the indicator-representative information, which is raw indicator data. As such, certain embodiments of the indicator positional converter mechanism 100 can provide a mechanism configurable to control a cruise control system by utilizing a camera or imager directed at the indicator such as a speedometer (or alternately an encoder that could detect motion of the indicator), and thereupon control the feedback mechanism that could be utilized as and/or input into a control mechanism such as the cruise control system.

Certain embodiments of the indicator positional converter mechanism 100 can also be configured to include an alarm that can be configured to allow the user or operator to know when items are about to expire. For instance, certain embodiments of the indicator positional converter mechanism 100 can utilize cameras, digital imagers, scanners, etc. to visually record and analyze their human-readable expiration dates. Another embodiment of the indicated positional converter mechanism 100 might utilize an enhanced display that can be configured to make it more easily read by the camera, imager, scanner, etc. Certain embodiments of the indicated positional converter mechanism may include a feedback associated with such imaging aspects such as focus, zoom, brightness, lightness, granularity, frequency of imaging, etc. such that a suitable image or data can be provided that may be representative of the information or data provided by the indicator 102.

Certain embodiments of the indicator positional converter mechanism 100 can thereby be configured to cause existing or new analog human-readable indicators (speedometer, altimeter, clock, etc.) to thereby act utilizing the feedback or control circuitry, in a similar manner as certain digital-based devices and/or control circuitry such as with cruise control, based on the position of hands, etc. As such, certain embodiments of older-style or legacy-style systems can be updated into newer operational, feedback, or control mechanisms to be able to operate similar to a newer system while appearing like an older or legacy system. Certain embodiments of the older or legacy system (such as older automobiles having legacy indicators or newer automobiles designed with legacy indicators) may utilize certain embodiments of the indicator detector 104 and/or the indicator data converter 106 as original or as add-on features. Other embodiments of new equipment can be designed or fabricated with certain embodiments of the indicator detector 104 and/or the indicator data converter 106 to maintain the appearance of legacy systems, which certain users or operators prefer. There are a number of individuals who prefer viewing and/or interfacing with the legacy or retroactive appearance of indicators (as compared with digital systems) while the indicators could provide the functionality of a more modern system. For instance, a driver of a legacy vehicle, such as a 1960's Ford Mustang convertible or a Jaguar (or even a more recent sports car having a number of legacy indicators) might not wish to update the indicators within their automobile with a digital speedometer, etc., but instead may wish to maintain the legacy look or feel of the indicators within their vehicle or system.

In general, there may be a number of reasons why it may be desirable to have a record, image, or indication of what an observer or user of certain embodiments of the indicator could observe, or could have observed at least partially by using certain embodiments of the indicator positional converter mechanism 100. It could be useful in regulatory situations, such as with aircraft navigation systems, nuclear power plants, railroad engineers, etc., to ascertain what the user or observer could detect. Records are one of the few mechanisms that can be utilized to determine whether a vehicle, a system, a process, a scene/site, etc. has been operated or maintained properly. For example, certain embodiments of the indicator positional converter mechanism 100 could answer such varied and potentially significant questions as, but not limited to: how fast was a train actually going as observed by the engineer along this section of track? What did the operators of a nuclear power plant or electric power grid actually see or have the opportunity to observe during a particularly critical period? Did the pilot who landed an aircraft act properly, or in a legal manner, based upon their indicators? Why did a captain run his ship aground? As certain embodiments of the indicator positional converter mechanism 100 become more accepted, it is easy to imagine more scenarios or regulatory systems to which variations or different embodiments of the indicator positional converter mechanism could be applied.

FIG. 9 thereby shows one embodiment of the indicator detector 104 that can include an imaging device 92. Certain embodiments of the imaging device 92, as described with respect to FIG. 9, can image raw indicator data corresponding to the indicator. As such, certain embodiments of the imaging device 92 can include, but are not limited to, a camera, an imager, a computer-based imaging device, etc. Certain embodiments of the imaging device 92 can utilize digital image processing techniques, such as those that are generally known in the digital camera or digital imaging technologies. As such, certain embodiments of the indicator detector 104 can utilize digital techniques and technologies based at least in part on the raw indicator data as provided by the indicator 102. Those embodiments of the indicator detector 104 that can image raw indicator data corresponding to the indicator may be associated with certain embodiments of the indicator data converter 106 that can convert image-based data into indicator-representative information.

FIG. 10 thereby shows one embodiment of the indicator detector 104 that can include an encoding device 94. Certain embodiments of the encoding device 94 as described with respect to FIG. 9 that can encode raw indicator data corresponding to the indicator can include, but are not limited to, optical encoders, digital encoders, electromechanical controllers, electromagnetic encoders, etc. Encoders are generally known, and those skilled in the encoding arts or technologies (such as might be applied to a large number of industries such as the automobile, aircraft, power-plant, manufacturing, or other indicator-based industry that can detect angular position changes, displacements, velocities, etc.) understand the use and design of encoders. Those embodiments of the indicator detector 104 that can encode raw indicator data corresponding to the indicator may be associated with certain embodiments of the indicator data converter 106 that can convert encoded-based data into encoder-representative information.

Certain embodiments of the indicator positional converter mechanism 100, which is referred to in this disclosure as “regulated” embodiments of the indicator positional converter mechanism 100, are configured to be operated in a manner consistent with regulations or laws. For instance, while the use of moving maps as described with respect to FIG. 8 has become relatively common, their use is regulated in certain areas such as personal travel, automobile travel, ship navigation, aviation navigation, etc. There are two aviation-based embodiments of moving map displays that are referred to as “handheld moving map displays” and “panel-mount moving map displays”. Handheld moving map displays to be used as a primary navigational tool in VFR (visual flight rules, such as flights that are being maintained clear of clouds and at lower altitudes).

Certain embodiments of the panel-mount moving map displays can be used in certain instances or configurations as a primary navigational tool in IFR (instrument flight rules, such as flights that can go within clouds where there is relatively low visibility or ceilings, or are conducted at higher altitudes where most larger commercial airliners fly). Global positioning system (GPS) technologies represent the vast majority, and the most reliable, of the panel-mount moving map displays currently being used in aviation. To certify a panel-mount moving map display for IFR flight, such requirements have to be satisfied as to ensure that the GPS system is acting properly, the GPS system is properly installed in the aircraft, the electrical or other system in the aircraft is not interfering with the GPS system, etc. To certify a moving map GPS-based display system, the moving map based display system may not act as a stand-alone device, and can be operationally associated with the navigational indicator as described with respect to FIG. 6. As such, if a particular approach is selected on the moving map display system, and the aircraft is performing that approach, and the aircraft is left of the desired course, the CDI needle 602 as illustrated in the indicator 102 of FIG. 6 should deflect to the right as illustrated in FIG. 6 based at least partially on the information obtained by the moving map (e.g., GPS) display.

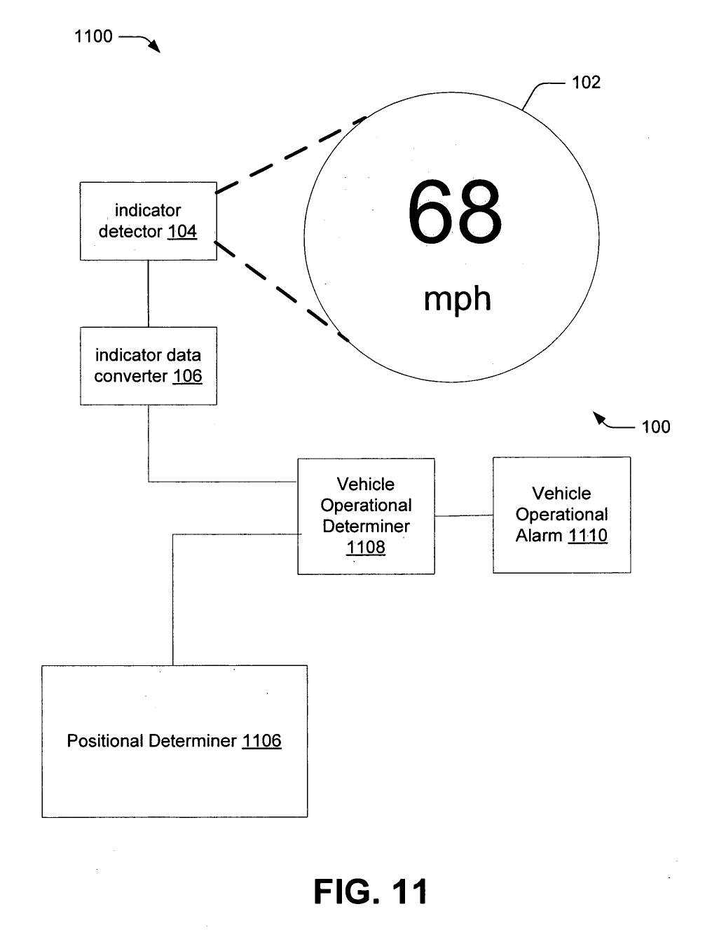

Consider that such information as whether the aircraft is positioned to one side of a desired course, as well as how far off the desired course the aircraft is, can be displayed both on the indicator 102 of FIG. 6, and on the moving map display of FIG. 8. It could be argued that such information is therefore redundant. However the Federal Air Regulations (FAR), which pilots are required to abide by, require such duplication of information. As such, proper use or installation of certain regulation-based indicators can be required by statute, regulation, law, etc. One reason why the duplication of the information between multiple indicators may be considered important is pilots have been trained to operate instruments similar to those of the indicator of FIG. 6, and navigation by purely moving-map can still be illegal since in many cases it may not be as precise as prior indicators. Additionally, certain “duplicative” indicators may be more reliable or precise than others, while other indicators may be more intuitive or user-friendly than others. There are also a number of other reasons for such duplication of information within one or more instruments, and it may be emphasized that navigating an aircraft in any manner inconsistent with the FARs can be dangerous and illegal. Another embodiment of vehicle operation that can utilize positional information combined with information obtained from the indicator 102 can utilize a vehicle operation feedback mechanism 1100 in certain embodiments of the indicator positional converter mechanism 100. Consider that GPS, or other similar technologies, can with allowable precision indicate where a train is situated. FIG. 11 shows one embodiment of a vehicle operational feedback mechanism 1100 that can utilize certain embodiments of the indicator positional converter mechanism 100 as described in this disclosure. In addition, the FIG. 11 embodiment of the vehicle operational feedback mechanism 1100 can include, but is not limited to, a positional determiner 1106, a vehicle operational determiner 1108 and a vehicle operational alarm 1110. Certain embodiments of the vehicle operational feedback mechanism 1100 as described herein can provide a feedback mechanism to ensure that a vehicle (such as but not limited to an aircraft, locomotive, ship, truck, military vehicle, submarine, etc.) is being operated properly based upon its particular position. Consider that certain sections of railroad tracks can have a maximum speed for other operating trains based upon the type of train, the weight of the train, the construction of the track, the location of the track (in a congested city or in the country), and other such factors. Certain embodiments of the railroad operation feedback mechanism 1100 can monitor, consider, or ensure that the train is being operated within those particular operating limits.

Certain embodiments of the positional determiner 1106 can include, but are not limited to: GPS, radar, and/or other electromagnetic, electronic, or other navigational or positional devices. Certain embodiments of the positional determiner 1106 can display a current position of the vehicle such as with the moving map or other display, while other embodiments simply output positional information in a manner that can be understood by the vehicle operational determiner 1108 or other suitable system.

Certain embodiments of the vehicle operational determiner 1108 can receive input from certain embodiments of the indicator positional converter mechanism 100 as described in this disclosure, as well as the positional determiner 1106 as described herein. Certain embodiments of the vehicle operational determiner 1108 can thereby determine where the vehicle is situated, and based upon that determination, what type of operation (speed limits, allowed times of operation, etc.) that vehicle is allowed to perform. Certain embodiments of the vehicle operational determiner 1108 can, for example, include such information that can be stored in database form such as, but not limited to: the type of vehicle, whether it is a train, aircraft, automobile, truck, military vehicle, etc.; and particular operational characteristics of that vehicle such as it should never be operated in excess of a certain speed. Such data can be maintained in a tabular form such as having limits of the vehicle conditional upon the weight of the vehicle.

Certain embodiments of the vehicle operational alarm 1110 can provide feedback to the operator or users whether, for example, the vehicle is being operated properly. For example, the train is going too fast or too slow for a particular track, an aircraft is going too fast or too slow for a particular airspace location, or another vehicle is going too fast or too slow for where they are situated, then that information may be displayed at a suitable location. Certain embodiments of the vehicle operational alarm 1110 can be provided, for example, on the face of certain embodiments of the indicator 102, in an audio or visual alarm, or by some modification of the vehicle such as an application of a braking mechanism. As such, in certain embodiments of the vehicle operational feedback mechanism 1100, when a vehicle such as a train, aircraft, car, truck, or military vehicle is operating outside of some prescribed parameter, an alarm can be provided to the operator and/or the operation of the vehicle can be modified either automatically and/or by application of an indicator, alarm, etc.

It is to be understood that certain embodiments of the vehicle operational feedback mechanism 1100 as described with respect to FIG. 11 can be applied to persons, as well. For example, certain persons could utilize certain embodiments of an indicator 100 that would indicate certain ones of their personal parameters, such as speed, etc.; and certain embodiments of the operational feedback mechanism 1100 can be applied to them to ensure that they're not traveling too fast or slow within that area that may be restricted or regulated for some reason or other, etc.

While the embodiment of the vehicle operational feedback mechanism 1100, as described with respect to FIG. 11, applies to certain embodiments of vehicles; it is to be understood as such concepts can also be applied to power plants, power grids, factories, offices, systems, machines, medical devices, and a variety of other mechanisms by which feedback mechanisms can be provided to ensure that the operation of the device is provided within the allowable regulations, limits, laws, etc.

Another embodiment of the positional converter mechanism is described with respect to FIG. 12, which shows one embodiment of an actuator positional converter mechanism 1200 that is configured to indicate an actual position of an actuator 1202 such as could be operated by an operator. Certain embodiments of the actuator 1202 can include, but are not limited to, a brake pedal, an accelerator, a throttle, a machine control mechanism, a medical device actuator, a device actuator, a switch, a lever, a toggle, etc. Consider that many of the concepts as described above in this disclosure relating to the actuator indicator positional converter mechanism 100 are largely applicable to the actuator positional converter mechanism. The block diagram of the indicator positional converter mechanism 100 as described with respect to FIG. 1 is thereby modified in FIG. 13 to reflect the embodiment of the actuator positional converter mechanism 1200, as compared to the indicator positional converter mechanism. For example, certain embodiments of the actuator positional converter mechanism 1200 can include, but are not limited to, the actuator 1302, an actuator detector 1304, and an actuator data converter 1306. Certain embodiments of the actuator detector 1304 can capture or encode raw actuator data that can indicate the position of the actuator, similar to what is described in FIG. 9 or 10 with respect to the indicator. As such, either an encoding technology, an imaging technology, and/or another suitable technology to determine a position of the actuator can be utilized. Certain embodiments of the actuator data converter 1306 can convert raw actuator data into suitable actuator positional information that can described the position, motion, velocity, acceleration, or other such activity of the actuator 1302.

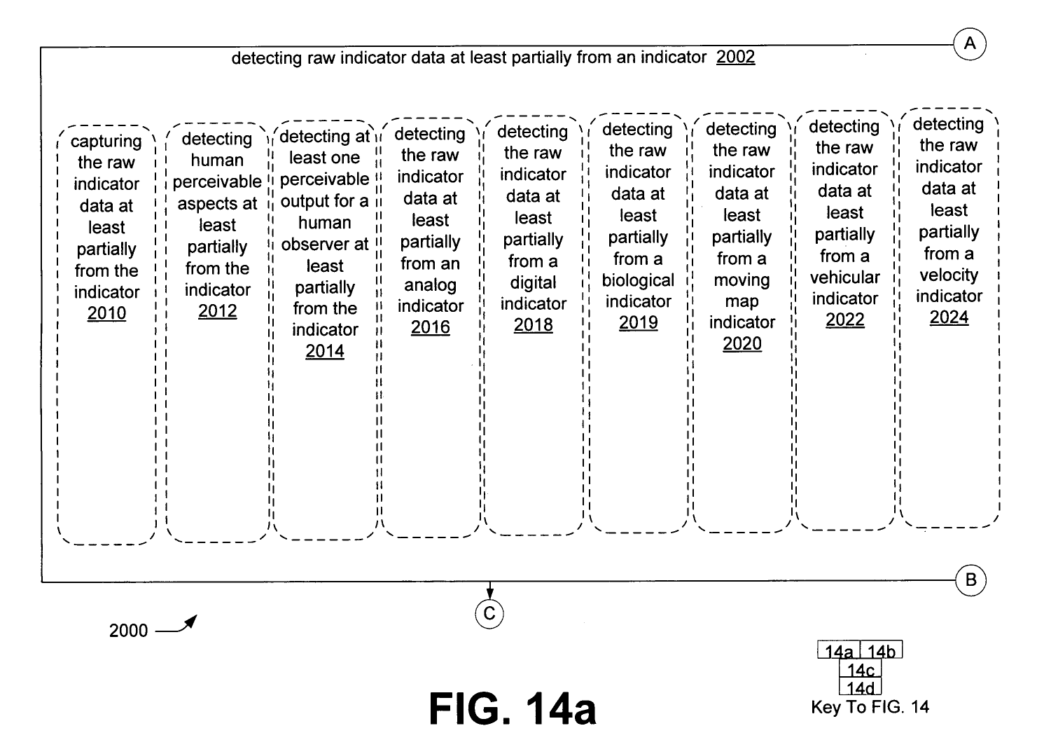

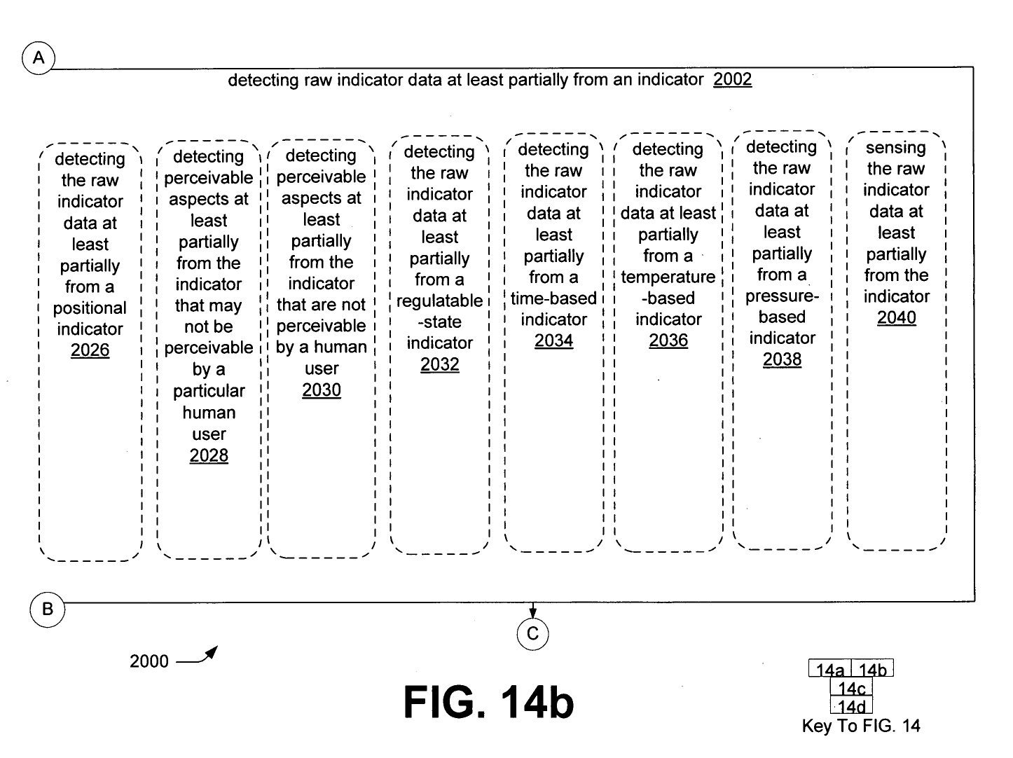

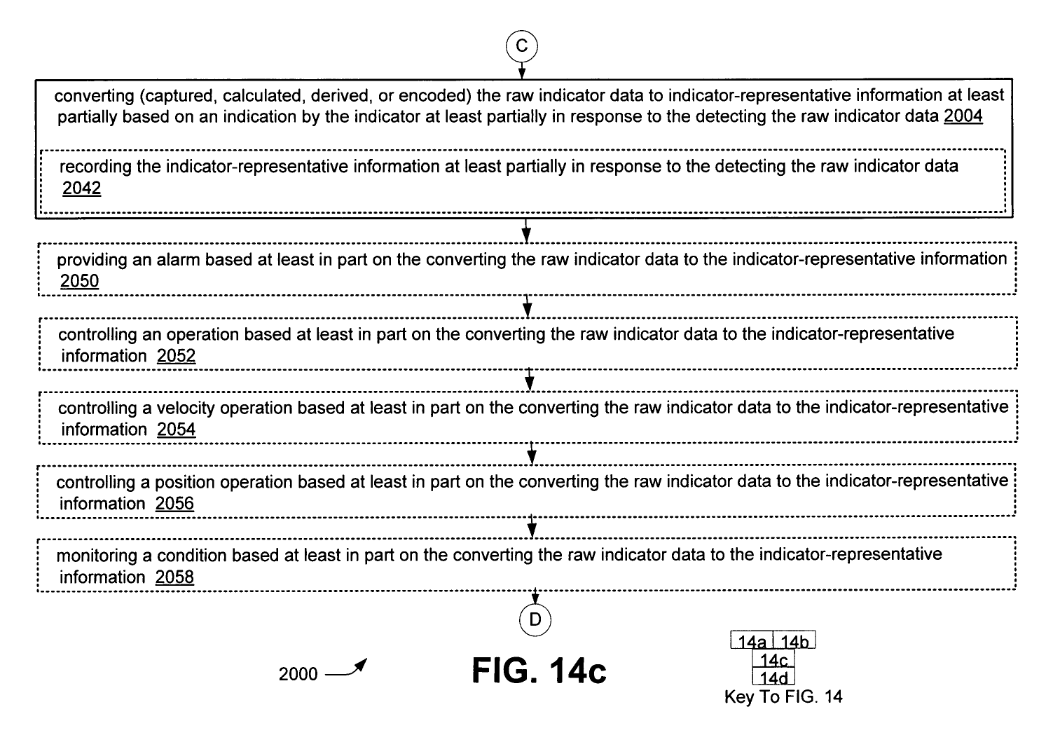

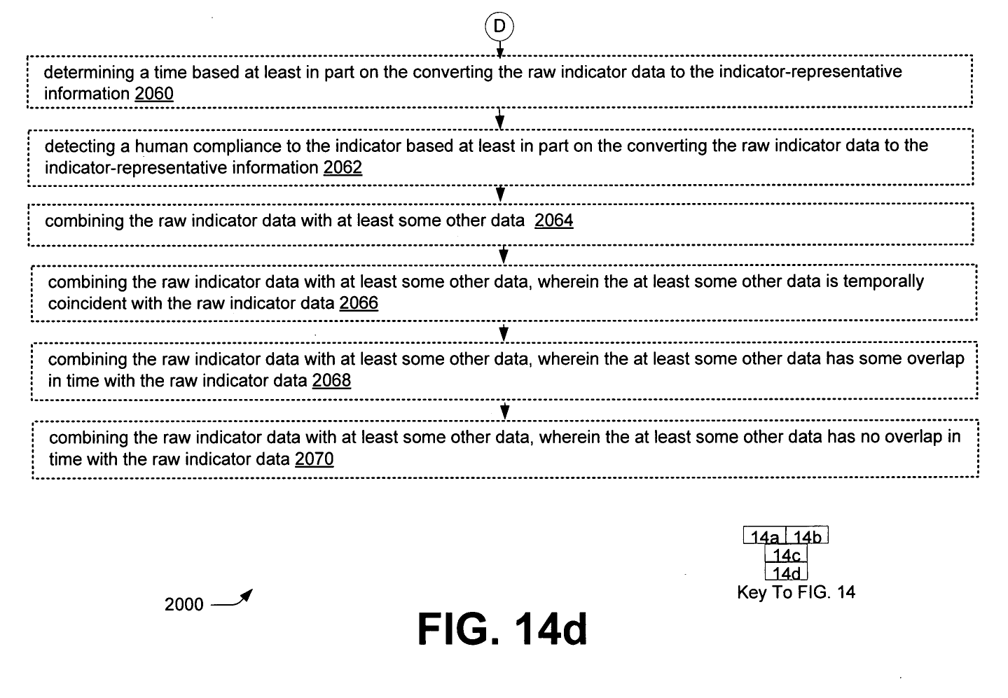

Within this disclosure, certain aspects of the indicator positional converter mechanism 100 as described in this disclosure with respect to FIGS. 1 to 11, and 14 (including FIGS. 14a, 14b, 14c, and 14d) as being applied to the indicator 102; can thereby also be applicable to the actuator positional converter mechanism 1200 with respect to FIGS. 12, 13, and 15 as being applied to the actuator 1302.

Certain embodiments of a feedback mechanism can similarly be associated with certain embodiments of the actuator positional converter mechanism 1200, similar to what is described with respect to FIG. 11 feedback mechanism associated with the indicator mechanism. As such, an alarm feedback mechanism is to be utilized by certain operators to determine if a vehicle is operated suitably. For example, certain embodiments of an automobile could have sensors to indicate that the front of the car is adjacent to a wall, thereby if pressure was sensed as being applied to the accelerator, an instantaneous alarm and/or feedback of it may be provided to limit the car being driven into a dangerous or damaging situation. In certain instances, the indicator positional converter mechanism 100 could even actuate a brake, or other control circuit, to remedy the dangerous, damaging, or illegal situation such as to shut down, brake, or accelerate, the vehicle such as a car. The number of control or feedback mechanisms that can be associated with certain embodiments of the actuator positional converter mechanism can be varied as provided by the imagination of the designer and/or user of the vehicle.

In addition, certain embodiments of the actuator positional converter mechanism 1200 can be applied to non-vehicle embodiments and situations such as power plants, power grids, offices, factories, external sites, sports arenas, etc. Certain embodiments of the actuator positional converter mechanism 1200 can thereby be applied to legacy or existing systems or vehicles, while other embodiments can be applied to new systems or vehicles. As such, there are a variety of reasons why it may be desired to provide a variety of embodiments of the indicator positional converter mechanism 100.

### 2. Certain Embodiments of the Indicator Converter Controller

This disclosure describes a number of embodiments of the indicator converter controller as described with respect to FIG. 1 that are intended to control operations of the indicator positional converter mechanism 100, or certain embodiments of the actuator positional converter mechanism 1200. Certain embodiments of the indicator converter controller or the actuator positional converter mechanism 1200 can act as and is provided the functionality of the at least a portion of the feedback mechanism to either certain embodiments of the indicator positional converter mechanism 100 as described with respect to FIG. 1, or certain embodiments of the actuator positional converter mechanism 1200 as described with respect to FIG. 12.

FIGS. 1 and 12 show a block diagram of certain respective embodiments of the indicator positional converter mechanism 100, or the actuator positional converter mechanism 1200, that can include the indicator/actuator converter controller 97. Certain embodiments of the indicator positional converter mechanism 100 thereby can include, but are not limited to, any particular configuration of the indicator/actuator converter controller 97. Certain embodiments of the indicator/actuator converter controller 97 can be computer based, controller based, mote based, and/or electronics based. Certain embodiments of the indicator converter controller can be segmented into modules, and can utilize a variety of wireless communication and/or networking technology to allow information, data, etc. to be transferred to the various distinct portions or embodiments of the indicator positional converter mechanism 100 or the actuator positional converter mechanism 1200. Certain embodiments of the indicator/actuator converter controller 97 can be configured as a unitary or stand alone device.

Certain embodiments of the indicator/actuator converter controller 97 can vary as to their automation, complexity, and/or sophistication; and can be utilized to analyze the at least one fluid(s) and/or element(s) withdrawn or aspirated from and/or injected into the individual, control the at least one fluid(s) and/or element(s) added to the individual, and/or control the at least one fluid(s) and/or element(s) withdrawn, aspirated and/or fluid injected relative to the individual. As described within this disclosure, multiple different embodiments of the indicator positional converter mechanism 100 or the actuator positional converter mechanism 1200 can transfer information about the vehicle, system, device, medical device, machine, etc., or their condition, information or data relating to the fluid(s) and/or element(s), signals, etc. via a communication link to or from a remote monitoring location and/or some intermediate device as might be associated with monitoring and/or other activities.

Certain embodiments of the indicator/actuator converter controller 97, as well as certain embodiments of the indicator positional converter mechanism 100 or actuator positional converter mechanism 1200 in general, can utilize distinct firmware, hardware, and/or software technology. For example, mote-based technology, microprocessor-based technology, microcomputer-based technology, general-purpose computer technology, specific-purpose to computer technology, and a variety of other computer technologies can be utilized for certain embodiments of the indicator/actuator converter controller 97, as well as certain embodiments of the indicator positional converter mechanism 100 or the actuator positional converter mechanism 1200.

Certain embodiments of the indicator/actuator converter controller 97, as described with respect to FIG. 1 or 12, can include a processor 803 such as a central processing unit (CPU), a memory 807, a circuit or circuit portion 809, and an input output interface (I/O) 811 that may include a bus (not shown). Certain embodiments of the indicator/actuator converter controller 97 of the indicator positional converter mechanism 100 or the actuator positional converter mechanism 1200 can include and/or be a portion of a general-purpose computer, a specific-purpose computer, a microprocessor, a microcontroller, a personal display assistant (PDA), a cellular phone, a wireless communication device, a hard-wired phone, and/or any other known suitable type of communications device, computer, and/or controller that can be implemented in hardware, software, electromechanical devices, and/or firmware. Certain embodiments of the processor 803, as described with respect to FIG. 1 or 12, can perform the processing and arithmetic operations for certain embodiments of the indicator/actuator converter controller 97 of the indicator positional converter mechanism 100 or the actuator positional converter mechanism 1200. Certain embodiments of the indicator/actuator converter controller 97 of the indicator positional converter mechanism 100 or the actuator positional converter mechanism 1200 can control the signal processing, database querying and response, computation, timing, data transfer, and other processes associated with certain embodiments of the indicator/actuator converter controller 97 of the indicator positional converter mechanism 100 or the actuator positional converter mechanism 1200.

Certain embodiments of the memory 807 of the indicator/actuator converter controller 97 can include a random access memory (RAM) and/or read only memory (ROM) that together can store the computer programs, operands, and other parameters that control the operation of certain embodiments of the indicator converter controller 97 of the indicator positional converter mechanism 100 or the actuator positional converter mechanism 1200. The memory 807 can be configurable to contain the defibrillation information or individual information obtained, retained, or captured by that particular indicator/actuator converter controller 97 of the indicator positional converter mechanism 100 or the actuator positional converter mechanism.

Certain embodiments of the bus can be configurable to provide for digital information transmissions between the processor 803, circuits 809, memory 807, I/O 811, and/or the image memory or storage device (which may be integrated or removable). In this disclosure, the memory 807 can be configurable as RAM, flash memory, semiconductor-based memory, or any other type of memory that can be configurable to store data pertaining to images. The bus also connects I/O 811 to the portions of certain embodiments of the indicator/actuator converter controller 97 of either the indicator positional converter mechanism 100 or the actuator positional converter mechanism 1200 that either receive digital information from, or transmit digital information to other portions of the indicator positional converter mechanism 100, the actuator positional converter mechanism 1200, or other system networking components, are associated with.

Certain embodiments of the indicator/actuator converter controller 97 of the indicator positional converter mechanism 100 or the actuator positional converter mechanism 1200, as described with respect to FIG. 1 or 12, can include a transmitter portion (not shown) that can either be included as a portion of certain embodiments of the indicator/actuator converter controller 97 of the indicator positional converter mechanism 100 or the actuator positional converter mechanism 1200. Certain embodiments of the indicator/actuator converter controller 97 can alternately be provided as a separate unit (e.g., microprocessor-based). In certain embodiments, the transmitter portion can transmit image information between certain embodiments of the indicator/actuator converter controller 97 of the indicator positional converter mechanism 100 or the actuator positional converter mechanism 1200.

Certain embodiments of the indicator/actuator converter controller 97 of the indicator positional converter mechanism 100 or the actuator positional converter mechanism 1200 as described with respect to FIG. 1 or 12 can include an operation altering portion (not shown) that can be either included as a portion of certain embodiments of the indicator/actuator converter controller 97 of the indicator positional converter mechanism 100 or the actuator positional converter mechanism 1200, or alternately can be provided as a separate unit (e.g., microprocessor-based). Examples of operation altering portions include, but are not limited to, altering a resolution, altering a contextual library, altering an aspect ratio, altering a color intensity and/or brightness or particular parameter or characteristic of the indicator positional converter mechanism 100 or the actuator positional converter mechanism 1200.

Certain embodiments of the memory 807 can provide one example of a memory storage portion. In certain embodiments, the monitored value includes but is not limited to: a percentage of the memory 807, a number of images that are stored in the memory 807, or for data storage or recording interval (audio or video recording intervals).

To provide for overflow ability for the memory 807 of certain embodiments of the indicator/actuator converter controller 97 of the indicator positional converter mechanism 100 or the actuator positional converter mechanism 1200, the image storage device can be operably coupled to the memory 807 to allow a controllable transmitting of memory data from certain embodiments of the indicator/actuator converter controller 97 of the indicator positional converter mechanism 100 or the actuator positional converter mechanism 1200 when the monitored value of data within the memory 807 (e.g., the memory storage portion) exceeds a prescribed value. The prescribed value can include, e.g., some percentage amount or some actual amount of the value.

In certain embodiments, a secondary communication link can be established between the certain embodiments of the indicator/actuator converter controller 97 of the indicator positional converter mechanism 100 or the actuator positional converter mechanism 1200. The secondary communication link can be structured similar to a communication link, or alternatively can utilize network-based computer connections, Internet connections, etc. to provide information and/or data transfer between certain embodiments of the indicator/actuator converter controller 97 of the indicator positional converter mechanism 100 or the actuator positional converter mechanism 1200.

Certain embodiments of the indicator/actuator converter controller 97 of the indicator positional converter mechanism 100 or the actuator positional converter mechanism 1200 can utilize one or more particular elements (e.g., the processor 803, the memory 807, the circuits 809, and/or the I/O 811), and can thereby provide a monitoring function to convert raw data as displayed by an indicator into information. A monitoring function as provided by certain embodiments of the indicator/actuator converter controller 97 of the indicator positional converter mechanism 100 or the actuator positional converter mechanism 1200 can be compared to a prescribed limit, such as whether the number of images contained in the memory 807, the amount of data contained within the memory 807, or some other measure relating to the memory is approaching some value. The limits to the value can, in different embodiments, be controlled by the user or the manufacturer of certain embodiments of the indicator/actuator converter controller 97 of the indicator positional converter mechanism 100 or the actuator positional converter mechanism 1200. In certain embodiments, the memory 807 can store such information as data, information, displayable information, readable text, motion images, video images, and/or audio images, etc.

In certain embodiments, the I/O 811 provides an interface to control the transmission of digital information between each of the components in certain embodiments of the indicator/actuator converter controller 97 of the indicator positional converter mechanism 100 or the actuator positional converter mechanism 1200. The I/O 811 also provides an interface between the components of certain embodiments of the indicator/actuator converter controller 97 of the indicator positional converter mechanism 100 or the actuator positional converter mechanism 1200. The circuits 809 can include such other user interface devices as a display and/or a keyboard. In other embodiments, the indicator/actuator converter controller 97 of the indicator positional converter mechanism 100 or the actuator positional converter mechanism 1200 can be constructed as a specific-purpose computer such as an application-specific integrated circuit (ASIC), a microprocessor, a microcomputer, or other similar devices. A variety of vehicles, factories, machines, medical devices, devices, locations, etc. could be configured to include certain embodiments of the indicator positional converter mechanism 100 or the actuator positional converter mechanism 1200. A variety of vehicles, seats, etc. can also be configured with certain embodiments of the indicator positional converter mechanism 100 or the actuator positional converter mechanism 1200.

### 3. Certain Embodiments of Indicator Positional Converter Mechanism with Relevant Flowcharts

Flow charts of the type described in this disclosure apply to method steps as performed by a computer or controller. The flow charts can also apply to apparatus devices, such as an antenna or a node associated therewith that can include, e.g., a general-purpose computer or specialized-purpose computer whose structure along with the software, firmware, electromechanical devices, and/or hardware, can perform the process or technique described in the flow chart.

One embodiment of a high-level flowchart of an indicator converter technique 2000 is described with respect to FIG. 14 (including FIGS. 14a, 14b, 14c, and 14d) and can include, but is not limited to, operations 2002 and 2004, and optional operations 2050, 2052, 2054, 2056, 2058, 2060, 2062, 2064, 2066, 2068, and/or 2070. One embodiment of operation 2002 can include, but is not limited to, optional operations 2010, 2012, 2014, 2016, 2018, 2019, 2020, 2022, 2024, 2026, 2028, 2030, 2032, 2034, 2036, 2038, and/or 2040. One embodiment of operations 2004 can include, but is not limited to, optional operation 2042. The high-level flowchart of FIG. 14 (including FIGS. 14a, 14b, 14c, and 14d) should be considered in combination with the embodiments of the indicator positional converter mechanism 100, as described with respect to FIGS. 1 to 11. One embodiment of operation 2002 can include, but is not limited to, detecting raw indicator data at least partially from an indicator. For example, the raw indicator data such as displayed on the face of the indicator, (consider for example the indicators as described with respect to FIGS. 1 to 8) can be detected. One embodiment of operation 2004 can include, but is not limited to, converting the raw indicator data to indicator-representative information at least partially based on an indication by the indicator at least partially in response to the detecting the raw indicator data. For example, raw indicator data can be converted (e.g., captured, calculated, derived, or encoded) into indicator-representative information based at least in part on the indication of the indicator (e.g., hands on an analog indicator, the digital value of a digital indicator, etc.). Certain embodiments of the converting the raw indicator data can include such processes that can include, but are not limited to: capturing, calculating, deriving, or encoding of the raw indicator data. One embodiment of the detecting raw indicator data at least partially from an indicator of operation 2002 can include operation 2010, that can include but is not limited to, capturing the raw indicator data at least partially from the indicator. For example, capturing the raw indicator data such as by imaging, photographing, or encoding the raw indicator data that can indicate a value of the indicator. One embodiment of the detecting raw indicator data at least partially from an indicator of operation 2002 can include operation 2012, that can include but is not limited to, detecting human perceivable aspects at least partially from the indicator. For example, detecting aspects of the indicator that can be, but are not necessarily, viewed by a human. One embodiment of the detecting raw indicator data at least partially from an indicator of operation 2002 can include operation 2014, that can include but is not limited to, detecting at least one perceivable output for a human observer at least partially from the indicator. For example, detecting at least one receivable output for the human observer. One embodiment of the detecting raw indicator data at least partially from an indicator of operation 2002 can include operation 2016, that can include but is not limited to, detecting the raw indicator data at least partially from an analog indicator. For example, wherein the raw indicator data at least partially includes data provided by an analog indicator, such as a positional-representative position of a speedometer, analog-thermometer, air-speed indicator, altimeter, etc. One embodiment of the detecting raw indicator data at least partially from an indicator of operation 2002 can include operation 2018, that can include but is not limited to, detecting the raw indicator data at least partially from a digital indicator. For example, wherein the raw indicator data at least partially includes data provided by a digital indicator, such as a digital temperature indicator, digital pressure indicator, digital watch or clock, etc. One embodiment of the detecting raw indicator data at least partially from an indicator of operation 2002 can include operation 2019, that can include but is not limited to, detecting the raw indicator data at least partially from a biological indicator. For example, wherein the raw indicator data at least partially includes data provided by a biological indicator, such as a biological media that can change color when a particular biological state is reached. One embodiment of the detecting raw indicator data at least partially from an indicator of operation 2002 can include operation 2020, that can include but is not limited to, detecting the raw indicator data at least partially from a moving map indicator. For example, wherein the raw indicator data is provided by a moving map indicator, such as a GPS, LORAN, or other indicator. One embodiment of the detecting raw indicator data at least partially from an indicator of operation 2002 can include operation 2022, that can include but is not limited to, detecting the raw indicator data at least partially from a vehicular indicator. For example, wherein the raw indicator data can provide at least some information about a vehicle. One embodiment of the detecting raw indicator data at least partially from an indicator of operation 2002 can include operation 2024, that can include but is not limited to, detecting the raw indicator data at least partially from a velocity indicator. For example, wherein the raw indicator data can provide at least some information about a velocity (of a vehicle or an object) which may be rectilinear or angular. One embodiment of the detecting raw indicator data at least partially from an indicator of operation 2002 can include operation 2026, that can include but is not limited to, detecting the raw indicator data at least partially from a positional indicator. For example, wherein the raw indicator data can provide at least some information about a position of an object or vehicle. One embodiment of the detecting raw indicator data at least partially from an indicator of operation 2002 can include operation 2028, that can include but is not limited to, detecting perceivable aspects at least partially from the indicator that may not be perceivable by a particular human user. For example, detecting the perceivable aspect that may not be perceivable by a particular human user based on, for example: position of the human user, condition of the human user, etc. Consider, for example, a speedometer which a particular user is too far away from to accurately monitor. One embodiment of the detecting raw indicator data at least partially from an indicator of operation 2002 can include operation 2030, that can include but is not limited to, detecting perceivable aspects at least partially from the indicator that are not perceivable by a human user. For example, certain indicators can be configured to translate information, data, etc. that is configured to or intended to be readable by computers, controllers, etc., but which may not be readily readable by humans. One embodiment of the detecting raw indicator data at least partially from an indicator of operation 2002 can include operation 2032, that can include but is not limited to, detecting the raw indicator data at least partially from a regulatable-state indicator. For example, certain indicators can provide regulatable-state information such as a speedometer on a locomotive or car, certain meters on a nuclear reactor, or certain indicators on an aircraft by which users or operators should remain within for regulatory, legal, or other purposes. One embodiment of the detecting raw indicator data at least partially from an indicator of operation 2002 can include operation 2034, that can include but is not limited to, detecting the raw indicator data at least partially from a time-based indicator. For example, the raw indicator data at least partially includes the time-based indicator. One embodiment of the detecting raw indicator data at least partially from an indicator of operation 2002 can include operation 2036, that can include but is not limited to, detecting the raw indicator data at least partially from a temperature-based indicator. For example, the raw indicator data at least partially includes temperature-based indicator. One embodiment of the detecting raw indicator data at least partially from an indicator of operation 2002 can include operation 2038, that can include but is not limited to, detecting the raw indicator data at least partially from a pressure-based indicator. For example, the raw indicator data at least partially includes the pressure-based indicator. One embodiment of the detecting raw indicator data at least partially from an indicator of operation 2002 can include operation 2040, that can include but is not limited to, sensing the raw indicator data at least partially from the indicator. For example, the detecting raw indicator data at least partially includes the sensing the raw indicator data. One embodiment of the converting the raw indicator data to indicator-representative information at least partially based on an indication by the indicator at least partially in response to the detecting the raw indicator data of operation 2004 can include operation 2042, which can include, but is not limited to, recording the indicator-representative information at least partially in response to the detecting the raw indicator data. For example, recording the indicator-representative information. One embodiment of operation 2050 can include, but is not limited to, providing an alarm based at least in part on the converting the raw indicator data to the indicator-representative information. For example, providing the alarm such as when a value of the raw indicator data reaches a prescribed value. One embodiment of operation 2052 can include, but is not limited to, controlling an operation based at least in part on the converting the raw indicator data to the indicator-representative information. For example, controlling the operation (e.g., a vehicle, a plant, an item of medical equipment, a process, a method, etc.) at least in part on the converting the raw indicator data to the indicator-representative information. One embodiment of operation 2054 can include, but is not limited to, controlling a velocity operation based at least in part on the converting the raw indicator data to the indicator-representative information. For example, controlling the velocity of a vehicle or object. One embodiment of operation 2056 can include, but is not limited to, controlling a position operation based at least in part on the converting the raw indicator data to the indicator-representative information. For example, controlling a position of a vehicle or object. One embodiment of operation 2058 can include, but is not limited to, monitoring a condition based at least in part on the converting the raw indicator data to the indicator-representative information. For example, monitoring a condition, such as a hazard condition, of a vehicle or object. One embodiment of operation 2060 can include, but is not limited to, determining a time based at least in part on the converting the raw indicator data to the indicator-representative information. For example, determining a time from a clock, watch, time indicator, etc. One embodiment of operation 2062 can include, but is not limited to, detecting a human compliance to the indicator based at least in part on the converting the raw indicator data to the indicator-representative information. For example, detecting whether a human is complying (e.g., to some regulation or law) based at least in part on the converting the raw indicator data to the indicator-representative information. One embodiment of operation 2064 can include, but is not limited to, combining the raw indicator data with at least some other data. For example, combining the raw indicator data with the at least some other data. One embodiment of operation 2066 can include, but is not limited to, combining the raw indicator data with at least some other data, wherein the at least some other data is temporally coincident with the raw indicator data. For example, combining the raw indicator data with the at least some other data that is temporally coincident with the raw indicator data. One embodiment of operation 2068 can include, but is not limited to, combining the raw indicator data with at least some other data, wherein the at least some other data has some overlap in time with the raw indicator data. For example, combining the raw indicator data with the at least some other data that has some overlap in time with the raw indicator data. One embodiment of operation 2070 can include, but is not limited to, combining the raw indicator data with at least some other data, wherein the at least some other data has no overlap in time with the raw indicator data. For example, combining the raw indicator data with the at least some other data that has no overlap in time with the raw indicator data. The order of the operations, methods, mechanisms, etc. as described with respect to FIG. 14 (including FIGS. 14a, 14b, 14c, and 14d) is intended to be illustrative in nature, and not limited in scope.

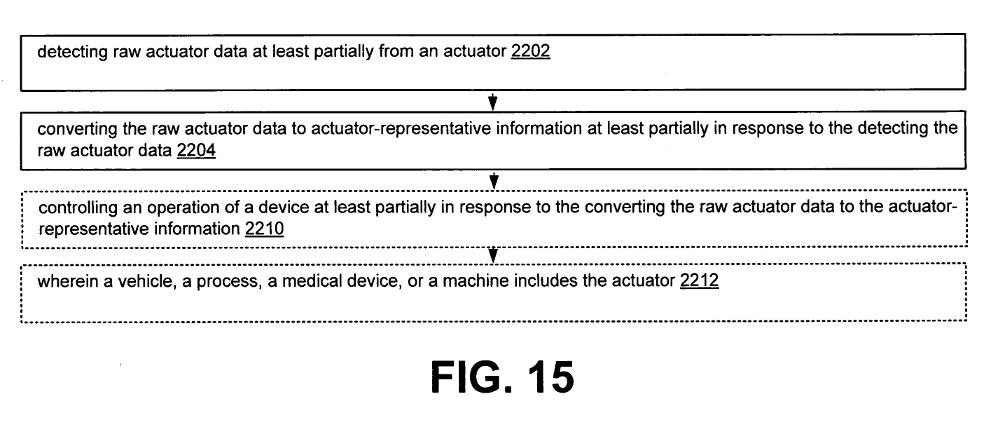

One embodiment of a high-level flowchart of an actuator converter technique 2200 is described with respect to FIG. 15 and can include, but is not limited to, operations 2202 and 2204, and optional operations 2210 and 2212. The high-level flowchart of FIG. 15 should be considered in combination with the embodiments of the indicator positional converter mechanism 100, as described with respect to FIGS. 12 and 13. One embodiment of operation 2202 can include, but is not limited to, detecting raw actuator data at least partially from an actuator. For example, detecting the raw actuator data from the actuator such as a vehicle, a process, a medical device, or a machine. Examples of the actuator that can be used on the vehicle, for example, can include but are not limited to operate pedal, an accelerator, a parking brake, a toggle, a switch, a windshield-wiper switch, etc. One embodiment of operation 2204 can include, but is not limited to, converting the raw actuator data to actuator-representative information at least partially in response to the detecting the raw actuator data. For example, converting the raw actuator data to the actuator-representative information that can include, but is not limited to, a digital representation of the raw actuator data. One embodiment of operation 2210 can include, but is not limited to, controlling an operation of a device at least partially in response to the converting the raw actuator data to the actuator-representative information. For example, controlling the operation of the device at least partially in response to the converting the raw actuator data to the actuator-representative information. One embodiment of operation 2212 can include, but is not limited to, detecting raw actuator data at least partially from an actuator wherein a vehicle, a process, a medical device, or machine includes the actuator. For example, one of a vehicle, a process, a medical device, or machine can include the actuator. In certain embodiments, the device can include, but is not limited to, a vehicle, a process, a medical device, or a machine, etc. The order of the operations, methods, mechanisms, etc. as described with respect to FIG. 15 is intended to be illustrative in nature, and not limited in scope.

In one or more various aspects, related systems include but are not limited to circuitry and/or programming for effecting the herein-referenced method aspects; the circuitry and/or programming can be virtually any combination of hardware, software, electromechanical system, and/or firmware configurable to effect the herein-referenced method aspects depending upon the design choices of the system designer.

### 4. Conclusion

This disclosure provides a number of embodiments of the indicator positional converter mechanism. The embodiments of the indicator positional converter mechanism as described with respect to this disclosure are intended to be illustrative in nature, and are not limiting its scope.

Those having skill in the art will recognize that the state of the art in computer, controller, communications, networking, and other similar technologies has progressed to the point where there is little distinction left between hardware, firmware, and/or software implementations of aspects of systems, such as may be utilized in the indicator positional converter mechanism. The use of hardware, firmware, and/or software can therefore generally represent (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle can vary with the context in which the processes and/or systems and/or other technologies are deployed. For example, if an implementer determines that speed and accuracy are paramount, the implementer and/or designer of the indicator positional converter mechanism may opt for mainly a hardware and/or firmware vehicle. In alternate embodiments, if flexibility is paramount, the implementer and/or designer may opt for mainly a software implementation. In yet other embodiments, the implementer and/or designer may opt for some combination of hardware, software, and/or firmware. Hence, there are several possible techniques by which the processes and/or devices and/or other technologies described herein may be effected, none of which is inherently superior to the other in that any vehicle to be utilized is a choice dependent upon the context in which the vehicle can be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

It is to be understood by those skilled in the art that, in general, that the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term “includes” should be interpreted as “includes, but is not limited to”; etc. In this disclosure and the appended claims, the terms “a”, “the”, and “at least one” positioned prior to one or more goods, items, and/or services are intended to apply inclusively to either one or a plurality of those goods, items, and/or services.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
detecting raw indicator data at least partially from an indicator; and
converting the raw indicator data to indicator-representative information at least partially based on an indication by the indicator at least partially in response to the detecting the raw indicator data.

2. The method of claim 1, wherein the detecting raw indicator data at least partially from an indicator comprises:
capturing the raw indicator data at least partially from the indicator.

3. The method of claim 1, wherein the detecting raw indicator data at least partially from an indicator comprises:
detecting human perceivable aspects at least partially from the indicator.

4. The method of claim 1, wherein the detecting raw indicator data at least partially from an indicator comprises:
detecting at least one perceivable output for a human observer at least partially from the indicator.

5. The method of claim 1, wherein the detecting raw indicator data at least partially from an indicator comprises:
detecting the raw indicator data at least partially from an analog indicator.

6. The method of claim 1, wherein the detecting raw indicator data at least partially from an indicator comprises:
detecting the raw indicator data at least partially from a digital indicator.

7. The method of claim 1, wherein the detecting raw indicator data at least partially from an indicator comprises:
detecting the raw indicator data at least partially from a biological indicator.

8. The method of claim 1, wherein the detecting raw indicator data at least partially from an indicator comprises:
detecting the raw indicator data at least partially from a moving map indicator.

9. The method of claim 1, wherein the detecting raw indicator data at least partially from an indicator comprises:
detecting the raw indicator data at least partially from a vehicular indicator.

10. The method of claim 1, wherein the detecting raw indicator data at least partially from an indicator comprises:
detecting the raw indicator data at least partially from a velocity indicator.

11. The method of claim 1, wherein the detecting raw indicator data at least partially from an indicator comprises:
detecting the raw indicator data at least partially from a positional indicator.

12. The method of claim 1, wherein the detecting raw indicator data at least partially from an indicator comprises:
detecting perceivable aspects at least partially from the indicator that may not be perceivable by a particular human user.

13. The method of claim 1, wherein the detecting raw indicator data at least partially from an indicator comprises:
detecting perceivable aspects at least partially from the indicator that are not perceivable by a human user.

14. The method of claim 1, wherein the detecting raw indicator data at least partially from an indicator comprises:
detecting the raw indicator data at least partially from a regulatable-state indicator.

15. The method of claim 1, wherein the detecting raw indicator data at least partially from an indicator comprises:
detecting the raw indicator data at least partially from a time-based indicator.

16. The method of claim 1, wherein the detecting raw indicator data at least partially from an indicator comprises:
detecting the raw indicator data at least partially from a temperature-based indicator.

17. The method of claim 1, wherein the detecting raw indicator data at least partially from an indicator comprises:
detecting the raw indicator data at least partially from a pressure-based indicator.

18. The method of claim 1, wherein the detecting raw indicator data at least partially from an indicator comprises:
sensing the raw indicator data at least partially from the indicator.

19. The method of claim 1, wherein the converting the raw indicator data to indicator-representative information at least partially based on an indication by the indicator at least partially in response to the detecting the raw indicator data comprises:
recording the indicator-representative information at least partially in response to the detecting the raw indicator data.

20. The method of claim 1, further comprising:
providing an alarm based at least in part on the converting the raw indicator data to the indicator-representative information.

21. The method of claim 1, further comprising:
controlling an operation based at least in part on the converting the raw indicator data to the indicator-representative information.

22. The method of claim 1, further comprising:
controlling a velocity operation based at least in part on the converting the raw indicator data to the indicator-representative information.

23. The method of claim 1, further comprising:
controlling a position operation based at least in part on the converting the raw indicator data to the indicator-representative information.

24. The method of claim 1, further comprising:
monitoring a condition based at least in part on the converting the raw indicator data to the indicator-representative information.

25. The method of claim 1, further comprising:
determining a time based at least in part on the converting the raw indicator data to the indicator-representative information.

26. The method of claim 1, further comprising:
detecting a human compliance to the indicator based at least in part on the converting the raw indicator data to the indicator-representative information.

27. The method of claim 1, further comprising:
combining the raw indicator data with at least some other data.

28. The method of claim 1, further comprising:
combining the raw indicator data with at least some other data, wherein the at least some other data is temporally coincident with the raw indicator data.

29. The method of claim 1, further comprising:
combining the raw indicator data with at least some other data, wherein the at least some other data has some overlap in time with the raw indicator data.

30. The method of claim 1, further comprising:
combining the raw indicator data with at least some other data, wherein the at least some other data has no overlap in time with the raw indicator data.

31. A method comprising:
detecting raw actuator data at least partially from an actuator; and
converting the raw actuator data to actuator-representative information at least partially in response to the detecting the raw actuator data.

32. The method of claim 31, further comprising:
controlling an operation of a device at least partially in response to the converting the raw actuator data to the actuator-representative information.

33. The method of claim 31, wherein a vehicle, a process, a medical device, or a machine includes the actuator.

34. An apparatus, comprising:
a raw actuator data detector configurable to detect raw actuator data at least partially relating to a position of an actuator; and
an actuator-representative information converter configurable to convert the raw actuator data to actuator-representative information at least partially in response to the detecting the raw actuator data.

35. An apparatus comprising:
an indicator detector configurable to detect raw indicator data at least partially from an indicator; and
an indicator data converter configurable to convert the raw indicator data to indicator-representative information at least partially in response to the detecting the raw indicator data.

36. The apparatus of claim 35, further comprising an indicator data combiner configurable to combine the raw indicator data with at least some other data.

37. The apparatus of claim 35, wherein the indicator detector includes an infrared detector configurable to detect raw infrared indictor data.

38. The apparatus of claim 35, wherein the indicator detector includes an industrial-state-based indicator detector.

39. The apparatus of claim 35, wherein the indicator detector includes a machine-state-based indicator.

40. The apparatus of claim 35, wherein the indicator detector includes a regulatable-state indicator.

41. An apparatus, comprising:
a raw actuator data detector configurable to detect raw actuator data at least partially relating to a position of an actuator of an item from a group, the group including at least one from a vehicle, a process, a medical device, or a machine); and
an actuator-representative information converter configurable to convert the raw actuator data to actuator-representative information at least partially in response to the detecting the raw actuator data.

42. A system, comprising:
detecting raw indicator data at least partially from an indicator;
combining the raw indicator data with at least some other information to at least partially form some combined information; and
converting the combined information to indicator-representative information at least partially in response to the combining the raw indicator data with at least some other information.

43. The system of claim 42, further comprising at least a portion for combining the raw indicator data with at least some other data.

44. An apparatus, comprising:
an indicator positional detector configurable to derive a state or position of an indicator to be used in a vehicle;
a positional determiner configurable to determine a position of the vehicle; and
a vehicle operational determiner configurable to determine a suitable operation of the vehicle based at least in part on the state or position of the indicator and based at least in part on the position of the vehicle.
